(19) United States
(12) Patent Application Publication
(10) Pub. No.: US 2026/0120126 A1
(43) Pub. Date: Apr. 30, 2026

(54) CASE FOR MOBILE COMPUTING DEVICES WITH INDEPENDENT PROCESSOR AND USER INTERFACE FOR AUGMENTING LABELS LINKED TO PRODUCTS

(71) Applicant: DrumWave, Inc., Palo Alto, CA (US)

(72) Inventor: André Vellozo, Palo Alto, CA (US)

(21) Appl. No.: 19/370,247

(22) Filed: Oct. 27, 2025

Related U.S. Application Data
(60) Provisional application No. 63/712,444, filed on Oct. 26, 2024.
(60) Provisional application No. 63/802,361, filed on May 8, 2025.

(51) Int. Cl. G06Q 30/0201; G06Q 20/40

(52) U.S. Cl. CPC G06Q 30/0201; G06Q 20/40145

(57) ABSTRACT

A smart case for a mobile computing device includes a protective housing having a touchscreen display, biometric sensor, processor, and memory configured to operate independently of the host device. The processor executes instructions that, upon authentication of a user, detect a transaction, present selectable options to characterize the transaction, and iteratively refine those options based on user selections. Data generated through these interactions may augment product-related records stored in a distributed data-ownership system that enables compensation to the user for authorized data access.

### CROSS-REFERENCE TO RELATED APPLICATIONS

This application claims the benefit of U.S. Provisional Patent Application No. 63/712,444, filed Oct. 26, 2024, and U.S. Provisional Patent Application No. 63/802,361, filed May 8, 2025, the entire contents of each of which are hereby incorporated by reference in their entireties.

### BACKGROUND

### 1. Field

The present disclosure relates generally to computer systems and, more specifically, to a case with independent processor and user interface for augmenting labels linked to products.

### 2. Description of the Related Art

Companies and consumers are willing to contribute data and benefit from the value data of the data they create in their relationships, such as data about their purchases, thought processes behind purchases, and experiences with their purchases if properly compensated, including company to company sharing, consumer to company sharing, and consumer to consumer sharing. Existing computing systems, however, generally leave consumers uncompensated, and so they are often hostile to use of their data by others, let alone willing to enrich and augment that data to facilitate improved uses of their data by third parties.

One challenge with getting parties to contribute data is the hardware used to gather that data. Often mobile computing devices, like smart phones, are slow and cumbersome to use for this purpose, e.g., often involving unlocking the same, navigating to an application, entering various fields of text, etc. At the same time, given the relatively expansive data about a person on their mobile computing device, some of those barriers are in place for a good reason, so merely re-programming a smart phone to, for instance, skip the unlocking step, or providing privileged operation to a native application, could be challenging for security reasons. As a result, parties to transactions may be less likely to augment data related to transactions.

### SUMMARY

The following is a non-exhaustive listing of some aspects of the present techniques. These and other aspects are described in the following disclosure.

Some aspects include a protective case configured to hold a mobile computing device on a first side of the protective case adjacent a back of the mobile computing device that is opposite a screen of the mobile computing device; a fingerprint sensor on a second side of the protective case, the second side being opposite the first side, such that the second side faces an opposite direction of the screen of the mobile computing device; a touchscreen display on the second side of the protective case; one or more processors and memory storing instructions that, when executed by the one or more processors effectuates operations comprising: detecting that a transaction has occurred after the fingerprint sensor has been used to confirm a person authorized the transaction; presenting a first set of options to characterize the transaction on the touchscreen display; receiving a selection among the first set of options via the touchscreen display; in response to the selection, presenting a second set of options to further characterize the transaction, the second set being selected based on the selection.

Some aspects include a process, including: receiving, as a result of a scan of a label on a product, a message identifying a person and a product obtained by that person; adding a record associating the person with the product to an account of the person; receiving a request to access the record from an entity other than the person; determining an amount of compensation to which the person is entitled in exchange for granting access to the record; and providing access to the record and causing the person to receive the compensation. In some cases, the process provides for ownership of data generated by relationships between entities (e.g., companies and consumers), in some cases specifying (at least in part) a format for the data and an application program interface schema to access the data when permitted, even when different entities have custody of different subsets of data relevant to a query.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1A is a perspective view of a smart case for a mobile computing device in accordance with some embodiments of the present techniques;

FIG. 1B is another view of the smart case of FIG. 1A;

FIG. 1C is a block diagram of the mobile computing device and the smart case in accordance with some embodiments of the present techniques;

FIGS. 1D, 1E, and 1F illustrate a user interface that may be presented on a touchscreen display of the smart case of FIGS. 1A-C in accordance with some embodiments of the present techniques;

FIG. 1G is a block diagram of a computing environment with a data controller computing system and label serving system, in accordance with some embodiments of the present techniques;

FIG. 2 is a flow chart of a process to label products with labels that link the act of obtaining those products with a data savings plan, in accordance with some embodiments of the present techniques;

FIG. 3 is an example of a computing device upon which the present techniques may be implemented; and

FIG. 4 illustrate a user interface that may be presented on a touchscreen display of the smart case of FIGS. 1A-C in accordance with some embodiments of the present techniques.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of computer science. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

In some cases, consumers, businesses, and others fail to enrich or supply data because of various forms of friction in the data entry process. Examples include the need to unlock and navigate to an application on their computing device, the need to type in various fields of information on that device, and the like (which is not to suggest that such steps or anything else herein is disclaimed).

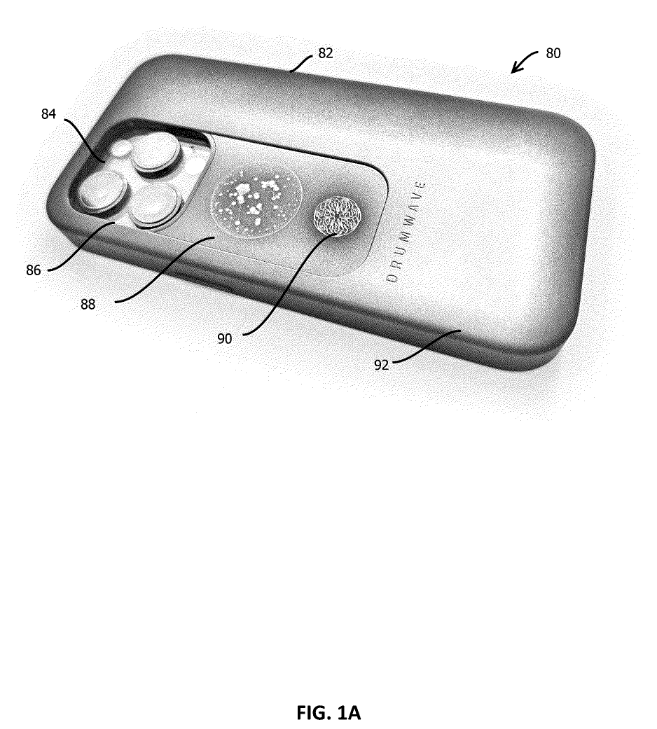

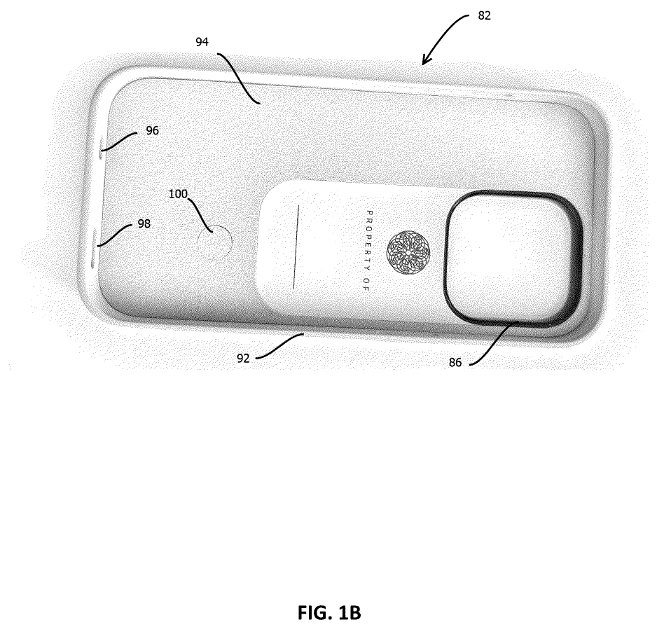

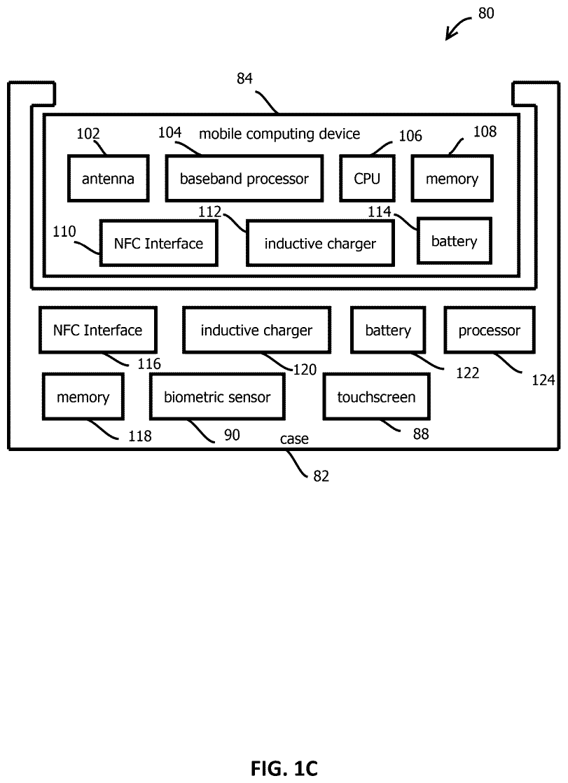

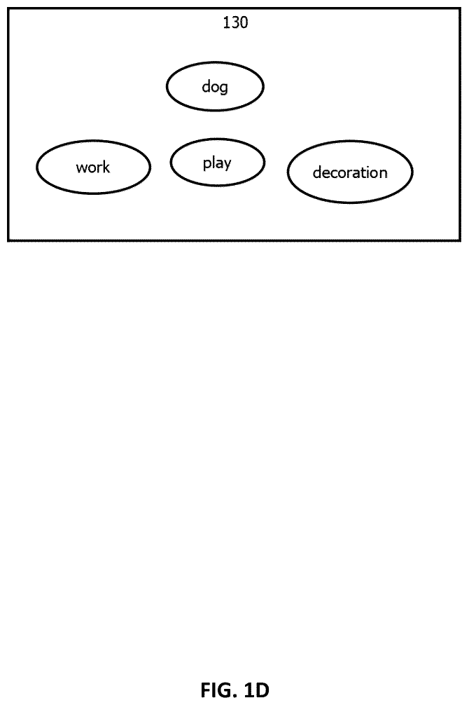

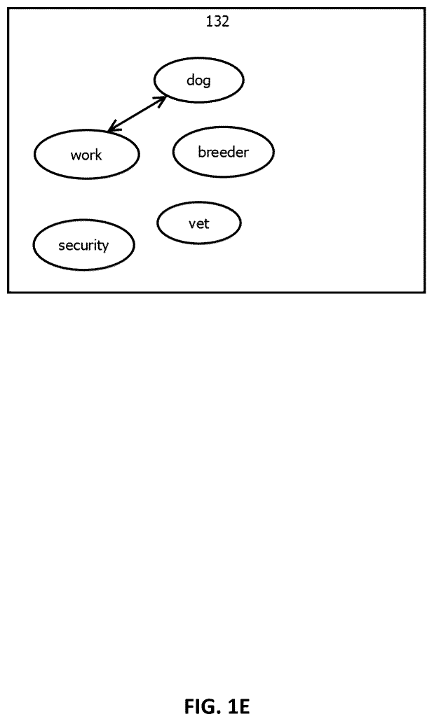

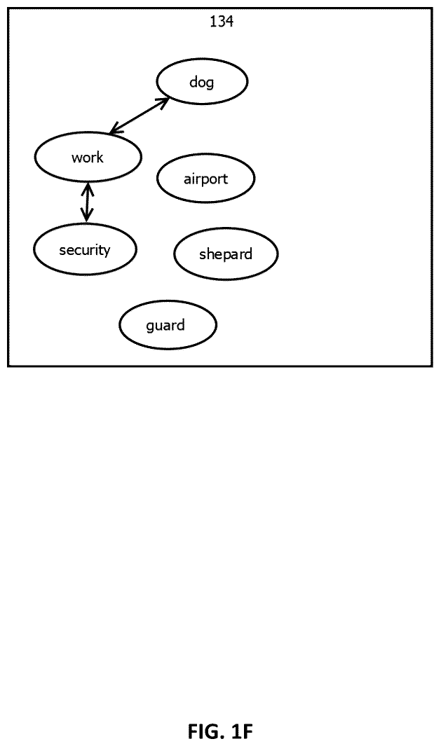

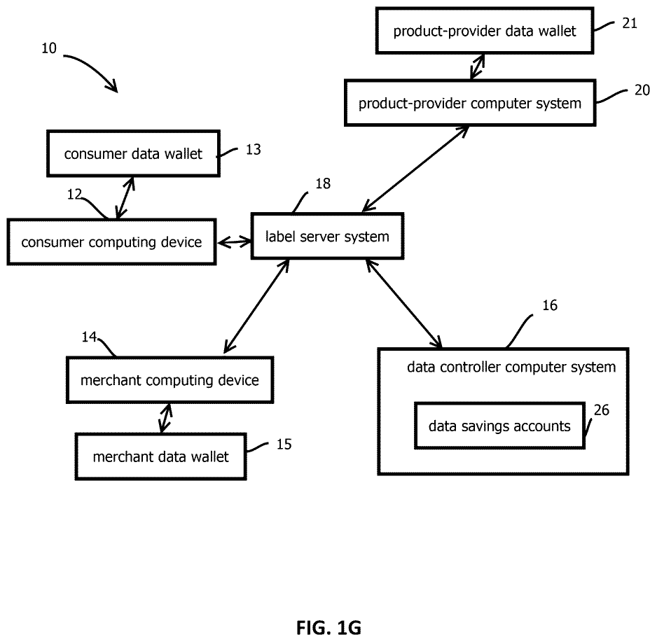

Some embodiments may mitigate these issues with an assembly 80, like that shown in FIG. 1A, which includes a smart case 82, like a data wallet, for a mobile computing device 84, such as a cell phone. In some cases, the smart case 82 may include an aperture 86 for the cameras of the computing device 84, a touchscreen 88, a biometric sensor 90, and a protective case 92 that at least partially envelops the mobile computing device 84 to protect it from falls.

In some embodiments, the touchscreen 88 is a capacitive touchscreen with a backlit light-emitting diode display, an organic light-emitting diode display, a transflective display, an electronic ink display, or the like. In some cases, the display is black and white, and in other cases, the display may be in color. In some embodiments, the biometric sensor 90 is a fingerprint sensor, though various other types of biometric sensors may be used, including retinal sensors, voice sensors, and the like.

In some embodiments, the case 92 may be made from materials that include thermoplastic polymers, elastomers, metals, natural materials, or composite materials. Thermoplastic polymers, such as polycarbonate or acrylonitrile butadiene styrene (ABS), may be molded to form a rigid protective shell that offers impact resistance. Elastomers, including thermoplastic polyurethane (TPU) or silicone rubber, may provide flexibility and shock absorption, allowing for impact mitigation in case of drops. Metals such as aluminum or titanium may be incorporated in some embodiments for durability and a premium aesthetic, though metal may impact signal transmission and may involve design considerations such as antenna windows.

In other embodiments, natural materials such as wood, leather, or cork may be used to offer aesthetic variety and may be bonded to or combined with synthetic materials to enhance protective characteristics. Composite materials, which may combine features of multiple base materials, may also be employed. For example, carbon fiber composites may be used in some embodiments to provide a lightweight yet strong case structure. Some cases may include additional coatings or treatments, such as hydrophobic coatings to resist moisture ingress or oleophobic coatings to reduce smudging.

FIG. 1B shows the other side of the smart case 82 with the mobile computing device (e.g., cell phone) removed. As illustrated, the sidewalls of the case 92 may envelop the sides of a mobile computing device. In some embodiments, the smart case 82 includes a backplate 94, for instance, made of a relatively soft, resilient material like felt covering a layer of plastic, to protect electronics, as described below with reference to FIG. 1C. In some embodiments, the smart case 82 includes various apertures 96 and 98 to charge the mobile computing device and allow audio to escape through speakers. In some embodiments, the smart case 82 includes an internal button 100 to turn the case on or off. It is expected that users will leave the smart case 82 on most of the time to provide a relatively low-effort, simple way to augment data as described below.

FIG. 1C is a block diagram of the assembly 80, including the mobile computing device 84 and the smart case 82. As illustrated, the mobile computing device may include an antenna 102, a baseband processor 104, a CPU 106, memory 108, a near-field communication (NFC) interface 110, an inductive charger interface 112, and a battery 114. In some embodiments, the smart case 82 may include an NFC interface 116, memory 118, an inductive charger interface 120, the biometric sensor 90, the touchscreen 88, a battery 122, and a processor 124.

In operation, in some embodiments, the smart case 82 may communicate with an application executing on the CPU 106 and stored in memory 108 of the mobile computing device 84 via the NFC interfaces 110 and 116. Alternatively, some embodiments may communicate via other wired or wireless interfaces, such as Wi-Fi™, Bluetooth™, infrared communication, and the like. In some embodiments, the battery 114 of the mobile computing device 84 may be charged via inductive charging through the inductive charger interface 112 and the inductive charger interface 120, drawing from the battery 122 of the smart case 82. In some cases, the flow of energy may be in the opposite direction. In some cases, the smart case may communicate with a remote server system, like those described below, via the mobile computing device's baseband processor 104 and antenna 102, such as via a cellular or satellite network.

In some embodiments, the smart-case processor executes a lightweight operating kernel configured to coordinate with an application programming interface (API) of the mobile operating system. Communications may include encrypted messages for event notification, authentication tokens, and power-management commands exchanged over Bluetooth Low Energy or near-field communication. In these embodiments, the firmware stack of the case may expose callable endpoints to register biometric events, trigger data-augmentation workflows, or initiate secure payment requests while maintaining isolation from the host device's secure enclave.

In operation, the smart case 82 may be used to pay for purchases, by accessing credentials in a secure enclave of the case 82 to effectuate transactions with a payment terminal in a store or online. In some embodiments, engaging in such a transaction may cause a user interface, like that shown below with reference to FIG. 1D, to appear, e.g., without the user unlocking their mobile computing device and without using payment credentials on the mobile computing device. In some embodiments, the smart case 82 may serve as one of the computing devices described below by which information about transactions is supplied. In some embodiments, that interface may be initialized based on information about the transaction available in the course of consummating the transaction. In some embodiments, the case may also include an inertial measurement unit operative to sense whether the case is facing down or up. In some embodiments, in response to detecting that the phone is placed face down, the smart case 82 may instruct the mobile computing device 84 to disable microphones and cameras to enhance the user's privacy.

Power-management logic may schedule sensor polling intervals and display refresh rates based on proximity or motion-sensing data. For example, the case may transition to a low-power sleep state when inertial data indicate prolonged inactivity, awakening upon detection of a grasp, fingerprint-sensor contact, or an NFC event. Bidirectional inductive charging between the case and the host device may be dynamically negotiated according to state-of-charge thresholds to optimize battery longevity.

FIG. 1D shows an example of a user interface 130 that may be presented on the touchscreen 88 described above in response to a user paying for a transaction or scanning a product, for instance, with the case 82 or the mobile computing device 84. In some embodiments, the user interface 130 may present entries in a taxonomy or ontology, for instance, a subset of a taxonomy selected based upon the transaction at hand. For example, the user may buy a dog toy, and the user interface 130 may present the options for further context on the word dog, like work, play, and decoration. In some embodiments, the options in the taxonomy may be selected based on proximity in an embedding space, such as those used with Word2Vec, or in some cases, a transformer architecture may be trained to predict the next selection as users advance through such taxonomies over time, with paths saved for training data. Further examples of this process are described below.

In some embodiments, a user may interact with the user interface 130 by drawing a line from the word “dog” to the word “work” to indicate that the reason they are buying something dog-related is for purposes of their work. This may cause the user interface to advance to the state shown in FIG. 1E, presenting user interface 132. As illustrated, in response to the selection, another set of options may be presented for the user to choose from using algorithms like those described above. In this example, the user may decide that they are buying something for their dog for their work, which is in the field of security, and draw a line from “work” to “security,” for instance, without even removing their finger from the screen, producing the user interface 134 shown in FIG. 1F. As illustrated, this may again cause another iteration of additional options to be presented. In some cases, this process may repeat between 2 and 10 times, such as between 2 and 4 times, with the user specifying in greater granularity more information about the reason for their transaction, such as their intent behind a purchase. It is expected that providing a user interface like those shown in these figures will offer a very low-friction, low cognitive load, easy way for consumers to provide context to their purchases for reasons that are incentivized through the operation of the system described below. Some embodiments may execute event handlers mapped to the region of the screen 88 displaying the options, and those event handlers may add that word to the description of the user's intent, which may be used to select the next set of options.

In some embodiments, algorithms used to implement the described user interface may employ a combination of natural language processing (NLP) and decision-making techniques to dynamically present a set of increasingly refined options. One approach may involve using proximity-based models such as word embeddings, where words or phrases are represented as vectors in a high-dimensional space, with the distance between vectors indicating their semantic similarity. In such cases, when the user selects a word (e.g., “work”), the algorithm may search the embedding space for related words that are close in distance, such as “breeder,” “vet,” or “security,” and present these as the next set of options. Word2Vec and GloVe (Global Vectors for Word Representation) may be used to generate such embeddings, where each word is mapped based on contextual similarity derived from a large corpus. The system may traverse this space to refine the user's expression of their intent, retrieving options that are contextually relevant based on the user's previous selections.

In some embodiments, transformers may be employed to handle sequential decision-making, where the relationship between a user's choices over multiple iterations may be modeled using self-attention mechanisms. Transformers, such as those seen in architectures like BERT (Bidirectional Encoder Representations from Transformers), may take the entire sequence of the user's selections into account when determining the next set of options. The attention layers in these models may allow the algorithm to weigh the significance of prior selections (e.g., “dog,” “work,” and “breeder”) to predict and present the next appropriate refinements (e.g., “puppies” or “training”). The process may iteratively narrow the user's input with each step, ensuring that the options presented remain relevant while accounting for the cumulative context of the user's selections.

Alternatively, in some embodiments, a Markov chain may be used to model the transition between states in the selection process. In this approach, each user selection may be treated as a “state,” and the algorithm may define probabilities for transitioning to the next set of options based on prior user interactions. For instance, if the user selects “work” followed by “breeder,” the algorithm may have predefined probabilities that suggest likely transitions to options such as “puppies” or “training.” This probabilistic model allows the system to make predictions about what options are most likely to follow based on previous choices, creating a chain of decisions that refine the user's input over several iterations.

Training datasets for the described models may include historical transaction records, product-category taxonomies, and user-interaction logs collected with consent. In some embodiments, inference may occur on the smart-case processor for latency-sensitive predictions, while model retraining and large-scale embedding updates are performed on a remote cloud system. The inference output may comprise a ranked list of candidate intents that are serialized and transmitted to the case display module for rendering. This arrangement enables real-time contextual refinement while maintaining resource efficiency on the accessory hardware.

In addition, clustering algorithms such as k-means may be used in some embodiments to categorize user selections into clusters that represent broader categories of intent. For example, if a large number of users selecting “dog” also select “work” and then “security,” the algorithm may identify these selections as part of a distinct cluster. When a new user makes similar selections, the system may direct them to options that are commonly chosen by other users in the same cluster. This method may improve the relevance of suggestions by learning from patterns in user behavior over time.

In some embodiments, a decision tree may be constructed where each node corresponds to a user selection and each branch represents a possible refinement. The tree structure may be dynamically generated based on predefined taxonomies or learned relationships between terms. For instance, the root node may represent broad categories like “dog,” and depending on the user's selection, the algorithm may traverse down the tree to present progressively narrower categories, such as “work,” “breeder,” and “puppies.” The decision tree may be pruned to eliminate less likely branches or expanded to incorporate new pathways based on evolving user behavior.

Other techniques that may be relevant include reinforcement learning, where the algorithm may learn an optimal sequence of refinements by rewarding paths that lead to successful user outcomes, or Bayesian networks, which may probabilistically model the dependencies between different user selections to predict the most relevant next step.

The hardware above may be used to supply or access data like that described below. It should be emphasized, though, that the techniques below may be implemented without using the hardware above, and the hardware above may be used in systems other than those described below, which is not to suggest that any other feature herein is limiting.

Some embodiments enrich physical products with a data layer, represented through a “data label” akin to a nutrition facts label, which in some cases integrates (e.g., includes or otherwise associates) both the product and its associated data. This label may be print or digital, potentially incorporating a QR code, bar code, radio-frequency identifier (RFID), near-field communication (NFC) identifier, or other machine-readable identifier, points to a dataset associated with the below-described rights to access and use information tied to the product and a product-user user, such as expiration dates, nutritional content, intent behind purchase, reviews, manuals, product specifications, or production details. By purchasing or otherwise scanning the product, in some embodiments, the product-user is granted an ownership right to this data, which may be automatically or manually transferred to a personal “data savings plan.” This plan may serve as a repository of the consumer's entitlements and data transactions, creating a bridge between the consumer, the product, and the company manufacturing or retailing (or leasing, or wholesaling, or otherwise making-available for users) the product.

Some embodiments afford a bi-directional relationship between companies and consumers, breaking the traditional model where companies silo the data from consumers or other companies. Some embodiments provide for business-to-business relationships, consumer-to-business relationships, and business-to-consumer relationships. Instead, in some embodiments, consumers become co-owners of the data generated through their interactions with products. The data savings plan, in some embodiments, allows consumers to store and potentially monetize their data, with companies sharing custody of the data in a “reserve account.” Over time, in some embodiments, consumers may benefit from this data in various ways, such as receiving product alerts, tracking dietary goals, or even selling data access to companies. This creates a feedback loop where the value of data is shared and leveraged by both parties.

Some embodiments afford a form of dynamic entitlement, where the value and access to data may change based on factors such as location, product recalls, or individual purchase behaviors. Some embodiments offer features well beyond those of a simple QR code (though QR codes may be used as a part of these approaches), which generally only offers one-way data sharing, by incorporating intent and meaning into the purchase itself, creating a mutually beneficial relationship between the consumer and the company. Some embodiments implement a computing infrastructure that not only assigns value to the data but also facilitates its contextual use, enhancing consumer experience while generating business value.

Some embodiments may implement a system akin to payment rails used in payment networks except for data. In addition, it is the case that different parties have custody of data that would be useful to some third party, but the cost, technical complication, and complexity of managing diverse data formats, negotiating terms and conditions associated with data access, and determining who has what rights and what data are too expensive. As such, many such transactions that could be beneficial to all parties do not occur due to these sources of friction. Some embodiments partially or fully specify a data format and application program interface by which data is read and written, and a system by which parties may automatically or partially automatically determine the value of data access and who is to be compensated for granting that access. A challenge with implementing a system like this is that there are often diverse types of data and terms that parties would like to attach to the ability to access that data. Some embodiments strike the appropriate balance between capturing default and widely preferred and useful design choices in these arrangements while remaining expressive enough to allow optimization without imposing excessive transaction costs.

In some embodiments, data custody is different from data ownership. In some embodiments, a party to a transaction that generates data may have an ownership stake in data characterizing that relationship, even though only their counterparty stores that data and has custody of it. In some cases, it may be businesses that have custody while their customers have some ownership in that data and the right to be compensated for its use. In some cases, the companies may also be compensated for that data's use, for instance, by other parties like other companies, responsive to micro contracts and with micropayments (that in the aggregate are expected to be substantial). The forms of standardization described here are expected to reduce friction when companies access data in the custody of other companies, among other benefits.

In some embodiments, a ledger subsystem records data-ownership metadata, including identifiers of generating entities, custodial entities, and associated compensation terms. Each transaction involving data access may append a cryptographically verifiable record specifying the policy identifier, valuation parameters, and consent status of participating entities. These records may be maintained in a distributed or cloud-hosted registry and synchronized with participants' data-wallet accounts.

In some embodiments, the data schema is referred to as a value schema system. In some embodiments, the label has a matrix structure with one dimension corresponding to entities like the maker of a product, the store where a product was sold, the seller of a product, and the buyer of a product. In some embodiments, another dimension of this matrix has categories of information like demographics, composition, process, and the like. In some cases, the label on a product is a pointer to the information stored in this matrix. In some embodiments, the label may capture the who, the what, the how, and the why related to how the product came to be obtained by a consumer.

In some embodiments, the data added by other parties may make products more attractive to consumers. For example, a consumer may value a product with a more expansive backstory, more detailed information relevant to their preferences, and more information about how to use and enjoy the product more highly than a product without that associated data. Further, a consumer may value a product more highly if that product carries with it the ability to be compensated for access to data generated by the consumer obtaining that product, enriching the data about that product, and otherwise engaging with that product. In some embodiments, a business account can enrich data about a product, for instance, by adding data to the label. And a consumer account can use that data. And those two entities can benefit from the data that they create together.

In some embodiments, the parties may have a data savings plan that separates the value of data from custody of the data. In some cases, the value of data may correspond to or be based on how full the label dataset is. For instance, half a dataset may be assigned half the value of a full dataset. In some cases, the percentage of a dataset that is full may be measured against a schema, like a value schema. In some cases, this value schema may be standardized across all products or partially standardized, for instance, with the templating system of hierarchical templates.

It is expected that a merchant's data savings account, which may also be called a reserve account, will have data about many consumers and many products, but not all of the products with which those consumers have had a relationship, as the consumers likely shop at other merchants as well. It is also expected that individual consumers will have data about many products from many merchants, and the full suite of data in which the consumer has an entitlement will be highly predictive of other things the consumer might enjoy or want in the future. In some cases, merchants may engage in transactions in which they compensate a collection of consumers sharing data ownership with one or more merchants to analyze that data, for instance, to determine aggregate population statistics or analyze individual consumers. The consumers and the merchants having an ownership stake in that data in their respective accounts may be compensated for this access and are expected to be incentivized to improve those datasets to make that access even more valuable.

In some cases, merchants may whitelist or blacklist other merchants from accessing their data, for instance, prohibiting direct competitors or adjust pricing for those parties, making it more expensive for their competitors to access their data. In some cases, data savings accounts may include records by which the holders specify how to automate their participation in transactions in which data access is provided in exchange for compensation. In some cases, parties may issue credit against later compensation provided to a person based on data in their data savings account. In some cases, entities like consumers or businesses may have multiple data savings plans that specify different rules for engaging in transactions in which they are provided compensation for access to data they own. In some cases, you may specify that your compensation is in the form of a contribution to a 529 plan, a 401k, a gift to your children, discounts on future products, reward points, or the like.

FIG. 1G is a block diagram illustrating an example of a computing environment 10, in which the techniques above may be implemented in some cases. Some embodiments include a consumer computing device 12, a merchant computing device 14, a data controller computing system 16, a label server system 18, a product provider computing system 20, and the internet or various other networks. In some cases, the product provider computer system 20 is communicatively coupled to a product provider data wallet 21. The consumer computing device 12 is communicatively coupled to a consumer data wallet 13. And the merchant computing device 14 is communicatively coupled to a merchant data wallet 15. In some cases, these data wallets may be co-located with the corresponding computing systems and devices. In some cases, they may be coupled by a local wireless area network or a wired connection, including via Bluetooth, near-field communication, Wi-Fi™, and the like.

Compensation events may be executed automatically via programmable contracts implemented on a permissioned distributed ledger. The contracts may reference standardized data-access policies defining allowable use, duration, and valuation methods. Upon satisfaction of policy conditions, a micropayment or token transfer may be executed to both the consumer's data-wallet and the merchant's reserve account. These transactions may also generate audit-trail entries that facilitate regulatory compliance and revenue recognition.

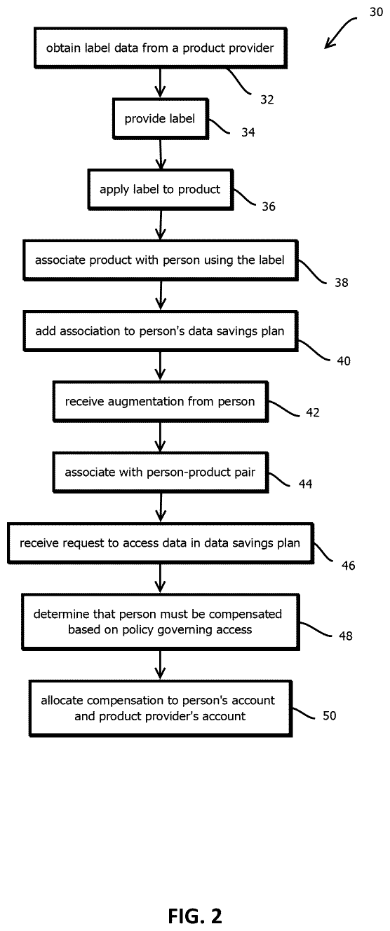

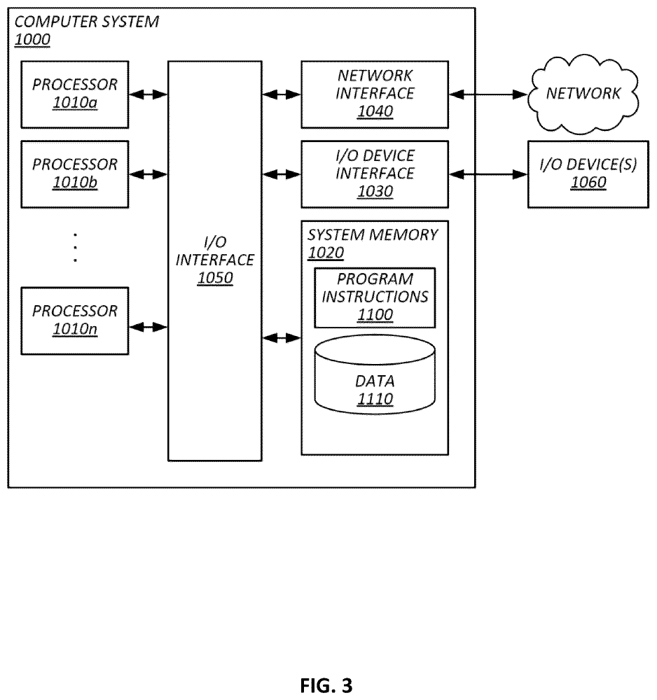

The various computing devices and computer systems may be implemented in a variety of forms. In some cases, the computer systems include a collection of computing devices. Or in some cases, the computer systems are individual computing devices. In some embodiments, the computing devices may be mobile computing devices such as cell phones, wearables (like augmented reality headsets or smart watches), tablet computers, laptops, or the like. In some embodiments the computing devices may be kiosks or desktop computing devices. In some cases, the computing devices may be check-out registers, for instance the merchant computing device 14 in some cases. The computing devices and computing systems may include the features of the computing device described below with reference to FIG. 3. Individual instances of each of the computing devices is shown in FIG. 1G, but contemplated embodiments are expected to include substantially more, such as thousands, tens of thousands, or more of each of the computing devices in systems 12, 14, and 20. In some embodiments, the illustrated components may cooperate to execute the process described below with reference to FIG. 2.

In some embodiments, the consumer computing device 12 may be used by a consumer to scan the labels described below, control who accesses their data, view reports on compensation for data access, and make decisions about who can access their data, and enrich or otherwise augment records indicating that they purchased the product created by scanning labels. In some embodiments, the consumer computing device may execute a native application in which these interactions occur, or in some cases the interactions described may be implemented in a web application viewed on a web browser executing on the consumer computing device 12.

In some embodiments, a merchant computing device 14, maybe a mobile device, tablet computer, desktop computer, or the like, by which a merchant interacts with the label server system 18 to populate forms to create labels, as described in greater detail below. In some cases, the same or another merchant computing device 14 may scan a product being purchased by a user, for instance at checkout, or process an online transaction in which a user purchases a product. In some cases, the merchant computing device 14 may be operative to associate an identifier of the consumer purchasing a product, for instance obtained with a merchant user profile on an online account or with a loyalty program card or with a credit card at in-store checkout with scanned label identifiers for reporting to the data controller computer system 16 at checkout, as described in greater detail below.

In some embodiments, the data controller computer system 16 may include data savings accounts 26 that track data over which consumers have control created by scanning product labels and providing enrichment information. The data wallets may store compensation provided to consumers in exchange for providing access to their data to others. In some cases, access is made by other merchant computing devices 14 seeking to market to consumers based on the data among a variety of other use cases described in greater detail below.

In some embodiments, the label server system 18 may be operative to receive information populated in forms by the product provider computer system 20 to create labels (like those described in greater detail below) that are scannable in order to link the act of purchasing a product (or otherwise obtaining a product) to a user's data savings account 26.

In some embodiments, the product provider computer system 20 is operative to populate forms provided to the label server system 18 to create labels that are received by the product provider computer system 20 for processing that results in the labels being applied to corresponding products. The products may be physical products like groceries, home appliances, automobiles, electronic devices, sporting goods, equipment, and the like; electronic media like music, video, games, movies, podcasts, books, and the like; or experiences, like hikes, shows, concerts, sporting events, weddings, and the like.

FIG. 2 is a flowchart showing a process 30 by which labels are created, scanned, and used to transact in data over which the person to which the data pertains has control and the right to compensation for third-party access. These steps of the process 30 may be executed by the computing devices described above with reference to FIGS. 1A-1G. These steps may be executed in a different order. Some steps may be repeated, some steps may be omitted, some steps may be performed concurrently, and the steps may be performed serially depending upon the embodiment, none of which is to suggest that any other illustrated feature is limiting.

The process 30 may include obtaining label data from a product provider, as illustrated by block 32. This data may be obtained from a product provider computer system 20, as shown in FIG. 1G. In some cases, the label server system 18 may host a web form into which a product provider employee supplies this information, for instance when creating a product catalog. In some cases, this information may be ingested by the label server system 18 via an application program interface (API) accessed by the product provider computer system 20, for instance programmatically creating labels based on a product catalog.

In some cases, a distinct label may be created for each brand, for each product family of a brand, for each model in a product family, for each instance of a model sold or to be sold, or in some cases, multiple labels may be created for each instance of a product provided, for example, in each chapter of a book or on each banana in a bunch to facilitate creation of data about consumption of the product. Some embodiments may have different labels for different sales channels or retailers as well.

In some cases, the information supplied may include specified fields that in some cases change depending upon the type of product. Some cases may include mandatory fields and optional fields. In some embodiments the provided data may be exclusively structured data or some embodiments may accommodate unstructured data like natural language text in prose form, images, computer aided design (“CAD”) models, and the like.

Examples of the type of data that may be supplied include anything on a traditional label, such as nutrition information, product specifications, country of origin, local provenance, certifications (like organic, kosher, etc.), expiration dates, manufactured dates, allergy warnings, safety warnings, and the like. Other examples include more expansive information like interactive media, the aforementioned CAD files or images or natural language to text, audio files, product definitions, stories about the creation of the product, stories about how others have used the product, links to related products such as compliments or consumables or products that consume the product and the like.

In some embodiments, the label server system 18 may create and provide a label responsive to the label data, as indicated by block 34. In some cases, creating the label may include creating an image that depicts the label, or in some cases data to render the label by the product provider computer system 20 may be provided. In some embodiments, the label may be a visual label that is recognizable to a human being looking at the object, providing visual cues on where to scan.

In some embodiments, the label encodes an identifier that is scannable. In some cases, the identifier is a global unique identifier within the computing environment described above with reference to FIG. 1G. In some embodiments, the identifier is unique to the manufacturer, to the manufacturer and retailer pair, to the manufacturer and the sales channel, to other forms of product providers, to the brand, to the model, to the particular instance of the model being sold where a production run of, for instance, a thousand units would result in a thousand different unique identifiers. In some embodiments, the label is unique to a subset of the products, for instance, different chapters in a book, different portions of a consumable product, or the like, such that a user can scan throughout consumption of a product to document their consumption and trigger scripts that prompt them to reorder or better inform how their data is used and make their data more valuable.

In some embodiments, the product provider may apply the label to a product, as indicated by block 36. In some embodiments, the label is a visually scannable label such that scanning the label with, for instance, computer vision tools (like QR code scanners or barcode scanners or cameras feeding into object detection and recognition computer vision algorithms) causes the unique identifier to be read. In some embodiments, the unique identifier is a uniform resource identifier (“URI”) or a uniform resource locator (“URL”) or a query string parameter of the same. In some embodiments, the identifier corresponds to, or is sent to, a network address and a resource accessible at that network address. In some embodiments, the label is embedded in an image, for instance, an image of the product with steganography. In some embodiments, the label is both human readable and machine readable, for instance, with optical character recognition (“OCR”) of images of the label. In some embodiments, the label is an image asset provided to the product provider to be included in a larger image or set of images used to print labels on the product. In some embodiments, the product provider applies the label as a sticker or a printed value that changes with each instance of the product. In some embodiments, the label takes the form of a RFID or NFC or other radio frequency device that is wirelessly scannable to read an identifier, like a passive or active scannable wireless chip.

Some embodiments of the process 30 include associating the product with the person using the label as indicated by block 38. For example, the label may be scanned when a person is purchasing the product or given the product. And the result of that scanning may cause the association to be formed. In some embodiments, part of making this association includes obtaining an identifier, like a global unique identifier of the person with whom the product is to be associated. In some cases, a product may be scanned at checkout, for instance, with a merchant, clerks, mobile computing device using a special purpose native application, or with a checkout register, in bricks and mortar sales. In some cases, the association may be formed when a product is purchased online by associating a person's account with the merchant with the product they are purchasing. In some cases, the person obtaining the product may initiate the association by scanning the label with their computing device, such as with the camera or NFC or RFID reader on their mobile computing device like their phone. In some embodiments, the person's mobile computing device may execute a special purpose native application that coordinates the scan (e.g., with a camera or antenna) and directs the association.

In some cases, the person is uniquely associated with the instance of the product they bought in a one-to-one relationship, where other people are not associated with that instance of the product, though a given person may have, and is expected to have, many products with which they are associated, as they consume more products over time. In some cases, many people who bought a product may be associated with that product. In some cases, where products are resold, different people may be associated with a given instance of a product over time.

In some cases, the product is an experience rather than a physical product. For example, a concert may display a label on a screen over a stage. A museum may display a label on a museum pass or at various exhibits. A sporting event may display a label on a field. A label may be applied by a national park service to waypoints along a hiking trail. A museum may display a label on a field. A museum may display a label on a field. In some cases, a person undergoing these experiences may scan these labels to create an association with those experiential products.

In some cases, the computing device associating the product with the person may cause the association to be added to the person's data savings account, as indicated by block 40. In some cases, this may be done by sending a communication to the data controller or computing system 16 described above, causing a record to be added to the data savings account 26 mentioned above. In some embodiments, a person may purchase the same product multiple times over the course of their engagement with the systems described herein, and a new association may be created for each purchase, or a counter or date stamp may be associated with the same person-product pair in an existing association with subsequent purchases.

In some cases, the association may form a record with additional fields. Examples include the date the product was obtained, the merchant from which the product was obtained, or the sales channel from which the product was obtained. Other examples include information provided by the product provider pertaining to the product like manuals, expiration dates, certifications, quantities included in the product, product attributes, product configuration, product specifications, user guides, safety information for the product, terms and conditions for accessing the product, or any licensed intellectual property used by or embodied by the product, audio or video content marketing associated with the same, and the like.

In some cases, the record documenting the association may be subject to a policy, like set of rules, a contract, laws, or the like that govern access to that data. In some cases, the person may have some control over that access and may be able to grant access in exchange for compensation. In some cases, the product provider may also have some control over that access. For example, both the product provider and the person may need to both provide consent for access. In some embodiments, the requirement for one or both of these forms of consent may be conditional upon the type of access and whether the access entails adequately aggregating the data to cross a threshold with respect to the amount of information revealed. For example, in some cases, access that does not require personally identifiable information or uniquely identify the product provider or the product may require access from only one of these parties or may not require consent depending upon how the accounts are configured by the various parties involved.

In some cases, each person may have a profile in the data savings plan in which similar records are stored with respect to each of the previous products they have scanned or have been scanned on their behalf. In some embodiments, there may be hundreds or thousands or more of such associations for hundreds or thousands or millions or more consumers in respective data savings plans. In some embodiments, the policies by which access is granted may be configurable by the person or the product providers or in some cases the same policy may be applied, for instance policies implemented by legal requirements. In some cases, different policies may be uniquely associated with different consumers accounts.

Because consumers are potentially compensated for access to the data in their data savings plan, in some embodiments, it is expected that consumers will be incentivized to make that data more attractive and useful to those potentially seeking access. In some cases, this may include the process 30 involving receiving augmentation from the person, as indicated by block 42. In some embodiments, the augmentation may be associated with the person product pair as indicated in block 44. In some cases, the augmentation may augment the record associating the person with the product. In some cases, that augmentation may be received from the person's consumer computing device 12 by the data controller computing system 16 for addition to the data savings accounts 26 (as discussed above with reference to FIG. 1G).

Augmentation may take a variety of forms. Examples include the user supplying their reason or other form of intent behind purchasing or otherwise obtaining the product, the user's review of the product, the user's rating of the product, or the other products with which the user intends to use the products like consumables, for instance forming a product graph in the data savings plans of products that are used together. Some embodiments may expose an ontology of intents behind purchase or otherwise obtaining products. In some cases, the ontology may be a hierarchical ontology having top-level categories like health, wealth, and work and then subcategories for instance under health like exercise, diet, and pharmaceuticals with even further subcategories to each of those in a tree data structure. In some cases that ontology may be exposed through a force-directed graph user interface in which the user navigates down through the ontology and can view various options that are semantically similar to one another, for instance with attraction between nodes in the force-directed graph corresponding to semantic similarity in an embedding space.

In another example, the user may be invited to augment by spoken audio, orally describing their reasons for purchasing the product, their review of the product, their rating of the product, or other products with which they intend to use the product. In some embodiments, this audio input may be provided to a speech-to-text model configured to output unstructured natural language text. That text may then be input to a large language model, trained or prompted to output structured data to augment the association between the person and the product, like the examples described elsewhere herein.

In some cases, users may indicate that they have made a recommendation for the product to another user, for instance, providing that user's identifier corresponding to their account in the data savings accounts 26, and their reason for making the recommendation. In some embodiments, the value of that recommendation may be scored, for instance, based upon whether that user receiving the recommendation actually later buys the product. In some embodiments, such recommendations may be promoted, compensated, or otherwise processed based upon a user's history of providing recommendations that result in purchases. Some embodiments may construct a social graph in which those recommendations are made, or score users according to an ontology of topics in which they might provide recommendations, which in some cases may correspond to the ontology of intents for purchasing products.

In some cases, the records associating people with products may be processed with scripts created for the consumers or by the consumers. Examples include a script that adds an expiration date to the user's calendar or schedules resupply of the product based upon historical usage patterns. Other examples include reminders to use the product, for example, exercise equipment being sent to the user, for example, as text message reminders or wearable device notifications. In some cases, guidance on how to use the product may be presented on a user's wearable computing device responsive to that user's wearable computing device detecting proximity to the product, for example, an RFID tag or NFC tag based upon information stored in these records.

In some cases, the augmentation may be used to train, or as input for, an artificial intelligence (AI) model configured to make product recommendations to a person, for instance, on behalf of product providers or on behalf of the person themselves. Examples include models operative to recommend resupplying products when they are close to being fully consumed or recommending complementary products or consumables for the product. In some cases, the AI model may be configured to engage in a conversation with the person as they deliberate potentially buying a product and discuss trade-offs and how they might view those trade-offs in view of their previous augmentation provided in their data savings plan. For example, an LLM may be configured to ingest as context augmentation pertaining to other products in the category historically provided by the user and then engage in a dialogue with the user as they evaluate potential options in the same category of goods to arrive at a recommendation. In another example, the augmented records associating products with people may be ingested by a recommendation engine configured to recommend products that the user potentially had not considered.

In some cases, these product recommendations and related advice may be presented in an augmented reality user interface or in an audio user interface. For instance, while a user is within a retail store or while the user is browsing her products online. Some embodiments may sense with a camera on a head-mounted display products or a category of products within the user's field of view and interrogate the artificial intelligence models described above to generate a visually overlaid, or audio, user interface recommending products that the user might like.

Some embodiments may receive a request to access data in the data savings plan, as indicated by block 46. In some cases, this request for access may be from another product provider, a marketer, a retailer, a government official, a researcher, a political campaign, or other parties wishing to better understand the user or a population of similar users, as indicated by block 46. In some cases, the request may specify a particular user, a category of users having particular demographic or psychographic attributes, a category of users having particular purchase histories or the like. In some cases, the request may specify a level of granularity of the request, for instance, requestion population statistics of such groups and specifying a minimum number of members of the groups. In some cases, the request may further specify a differential privacy protocol, for instance, a measure of variance (like standard deviation) applied to a Gaussian distribution sampled from to introduce noise into the results to further protect the user's privacy. In some cases, the size of that measure of variance may correspond inversely with the amount of compensation provided to users, such that greater noise being injected corresponds to lower compensation and less loss of privacy. In some cases, the request is received by the data controller computing system 16 described above, for instance, from another product provider computing system 20.

Access policies may integrate privacy-preserving computations, including differential-privacy mechanisms that introduce statistical noise, k-anonymity grouping, or encrypted query processing using homomorphic techniques. These measures enable third-party analytics while ensuring that personally identifiable or proprietary information remains protected. In some embodiments, privacy budgets may be dynamically adjusted based on user consent preferences and historical compensation levels.

Some embodiments may determine that the person must be compensated based on the policy governing access, as indicated by block 48. In some cases, this may include retrieving the person's policy and applying its rules specific to that person, or this may be done based on an overarching policy that applies to all users or a subpopulation of users or product provider records. In some cases, the step may include determining that the product provider may also be required to provide consent and be incentivized with compensation. In some cases, these parties may specify in advance their terms for expected compensation minimums to provide access, or in some cases a request for access may be sent and conditioned upon post-request consent being provided by the relevant parties via their respective computing devices. In some cases, users may specify their compensation based upon a measure of entropy or information by which they can be distinguished from members in a larger population, like all users, given the information for which access is requested. In some cases, more information and lower entropy may correspond to higher compensation being required. Compensation may take a variety of forms, including monetary compensation, increasing a score tracking a user's contribution to the system, providing cryptographic tokens or non-fungible tokens, providing coupons, discounts, or other offers, or the like.

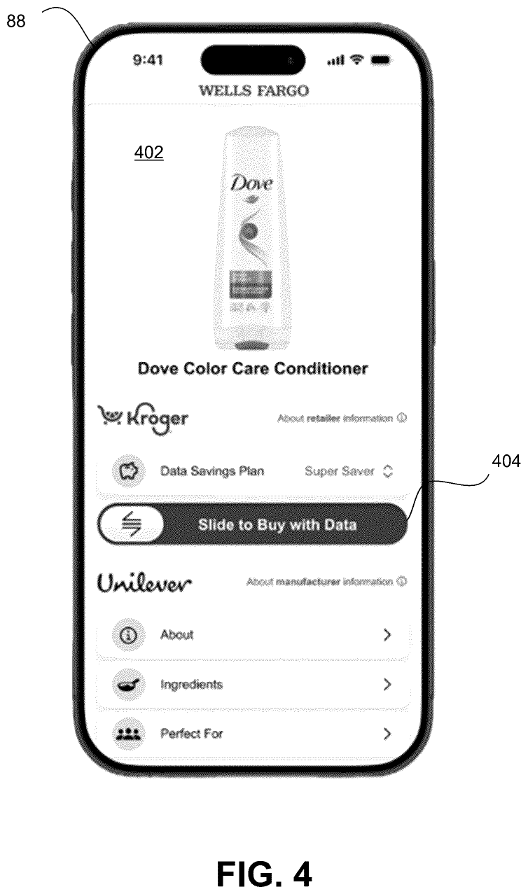

For example, FIG. 4 shows an example of a user interface 402 that may be presented on the touchscreen 88 described above where a user has an option to be compensated for data by being able to buy a product with data. The user may proceed to checkout and be presented with an option to pay with data for a good or service. In the illustrated example, the user may slide or tap a button 404 that initiates the system to transfer the user's data to the entity offering the product or another entity that is compensating the entity that is providing the product for sale. As such, a user may be compensated for data by receiving a good or service or crediting an amount toward/discounting a good or service. When activating the button 404, the user enables an expedited electronic commerce transaction through a single user action, such as a button click or tap. The user may initiate an order for an item without the need for entering data information, payment information (if needed), or shipping information during each transaction.

Upon activation of the button 404, the consumer computing device 12 may transmit a transaction request including a product identifier and a user session token to a backend transaction processing system provided by the product-provider computing device 20 or the merchant computing device 14. The backend system may retrieve pre-stored purchaser information associated with the session token, including at least one default payment method (e.g., data as payment) and a designated shipping address, from a secure data repository. The system may then performs a series of validation operations, including verification of inventory availability, data as payment method authorization via the label server system 18 and data controller computer system 16, and confirmation of shipping address eligibility. If all validation operations succeed, the system reserves the item within an inventory management module to prevent concurrent purchases, finalizes data transfer authorization, and generates an order record for downstream fulfillment operations. The transaction may be processed asynchronously, with relevant purchase and system state events being logged to one or more analytics and monitoring services for performance optimization and audit compliance. This system significantly reduces the latency and enhances user convenience by minimizing the cognitive and mechanical effort required to complete a purchase.

Some embodiments may allocate compensation to the person's data savings account and the product provider's account based on the determination in block 48, as indicated by block 50. In some cases, a record describing the user's compensation, for instance, a ledger tracking their compensation may be added to their data wallets, described above with reference to FIG. 1A-1G. In some cases, the records may be updated in, for instance, a banking system to reflect additions made to a user's banking account.

In some cases, identifiers of people and product providers may identify them in a pseudonymous way or the identifiers may identify them explicitly, qualifying in both cases as an identifier. References to a message singular conveying various fields of information include multiple communications conveying that information, in some cases with intermediate communications back to the sending party intervening, as well as a single communication conveying all of that information. Reference to identifying a product includes identifying a brand, identifying a model provided by that brand, or identifying a specific instance of that model that was sold or otherwise provided.

In some cases, the present techniques may be implemented with those described in the following, each of which is hereby incorporated by reference: U.S. patent application Ser. No. 17/535,413 (having docket no. 043638-0564878), titled METHOD OF SCORING AND VALUING DATA FOR EXCHANGE; U.S. patent application Ser. No. 18/514,536 (having docket no. 043638-0577902), titled CROSS-DEVICE DATA DISTRIBUTION WITH MODULAR ARCHITECTURE; US Pat. App. 63/637,144 (having docket no. 043638-0577054), titled METHOD OF SCORING AND VALUING COMBINATIONS OF DATA FOR EXCHANGE; and U.S. patent application Ser. No. 17/959,842 (having docket no. 043638-0458797), titled APPLICATION DATA EXCHANGE SYSTEM.

FIG. 3 is a diagram that illustrates an exemplary computing system 1000 in accordance with embodiments of the present technique. A single computing device is shown, but some embodiments of a computer system may include multiple computing devices that communicate over a network, for instance in the course of collectively executing various parts of a distributed application. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n ) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n ). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n ) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n ) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n ). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following first set of enumerated embodiments:
1. A computer-implemented method, comprising: receiving, with a computer system, as a result of a scan of a label on a product, a message identifying a person and a product obtained by that person; adding, with the computer system, a record associating the person with the product to an account of the person; receiving, with the computer system, a request to access the record from an entity other than the person; determining, with the computer system, an amount of compensation to which the person is entitled in exchange for granting access to the record; and providing, with the computer system, access to the record and causing the person to receive the compensation.
2. The method of embodiment 1, comprising: receiving data from the person characterizing the person's relationship with the product; and augmenting the record with the data characterizing the person's relationship with the product.
3. The method of embodiment 2, wherein data specifies an entry in an ontology of candidate reasons for obtaining the product.
4. The method of embodiment 2, comprising: inputting the data characterizing the person's relationship with the product into a trained artificial intelligence model to assist the person with a decision regarding another product.
5. The method of embodiment 1, wherein:

the label comprises a computer-readable code that identifies the product and locates a network-accessible resource with information about the product.
6. The method of embodiment 5, wherein the computer-readable code is an optically readable code.
7. The method of embodiment 5, wherein the computer-readable code is a wirelessly readable code.
8. The method of embodiment 5, wherein the computer-readable code is encoded on the product with steganography.
9. The method of embodiment 1, wherein the compensation is determined based on an amount of entropy entailed by the requested access.
10. The method of embodiment 1, wherein the scan is performed by a computing device of the person.
11. The method of embodiment 1, wherein the scan is performed by a retailer of the product.
12. The method of embodiment 1, comprising causing the person to be reminded of an expiration date or use by date of the product based on the record.
13. the method of embodiment 1, comprising: receiving a selection from the person from among a hierarchical ontology of reasons for purchasing the product.
14. The method of embodiment 13, wherein: the ontology is presented in a force-directed graph user interface.
15. the method of embodiment 14, wherein force in the graph is based on distance in an embedding space of entries in the ontology.
16. The method of embodiment 13, wherein the selection is based on audio of the person speaking about their relationship with the product input to a speech-to-text model.
17. the method of embodiment 1, wherein: the record is stored in a data savings account of the person, in a repository having more than 10,000 other data savings accounts of other people, and the data savings account of the person has more than 20 records corresponding to purchases of more than 20 different respective products.
18. A tangible, non-transitory, machine-readable medium storing instructions that when executed by a data processing apparatus cause the data processing apparatus to perform operations comprising: the operations of any one of embodiments 1-17.
19. A system, comprising: one or more processors; and memory storing instructions that when executed by the processors cause the processors to effectuate operations comprising: the operations of any one of embodiments 1-17.

The following will also be better understood with reference to the following second set of enumerated embodiments:
1. A case for a mobile computing device, the case comprising: a protective case configured to hold a mobile computing device on a first side of the protective case adjacent a back of the mobile computing device that is opposite a screen of the mobile computing device; a fingerprint sensor on a second side of the protective case, the second side being opposite the first side, such that the second side faces an opposite direction of the screen of the mobile computing device; a touchscreen display on the second side of the protective case; one or more processors and memory storing instructions that, when executed by the one or more processors effectuates operations comprising: detecting that a transaction has occurred after the fingerprint sensor has been used to confirm a person authorized the transaction; presenting a first set of options to characterize the transaction on the touchscreen display; receiving a selection among the first set of options via the touchscreen display; in response to the selection, presenting a second set of options to further characterize the transaction, the second set being selected based on the selection.
2. The case of embodiment 1, comprising: a battery configured to power the one or more processors, the touchscreen display, the memory, and the fingerprint sensor; and a local area wireless interface configured to communicate with the mobile computing device to engage an antenna of the mobile computing device to convey data from the one or more processors to a remote server system.
3. The case of embodiment 1, wherein: the second set of options are selected based on proximity in an embedding space.
4. The case of embodiment 1, wherein the operations comprise: determining that an orientation sensor of the case indicates the mobile computing device has been placed screen-side down; and in response to the determination, causing, by the one or more processors, a microphone and a camera of the mobile computing device to be disabled.
5. The case of embodiment 1, wherein another selection among the second set of options is obtained in response to detecting that a touch from the first selection has been drawn to a region of the touchscreen display corresponding to one of the second set of options.
6. The case of embodiment 1, the first set of options and the second set of options being individual words.
7. The case of embodiment 1, wherein the one or more processors are configured to operate independently of a processor of the mobile computing device, while the mobile computing device is locked.
8. The case of embodiment 1, comprising an inductive charging interface.
9. The case of embodiment 1, wherein the inductive charging interface is configured to convey power from the battery to charge the mobile computing device.
10. The case of embodiment 1, wherein the inductive charging interface is configured to convey power from the mobile computing device to charge the battery.

What is claimed is:

1. A case for a mobile computing device, the case comprising:
a protective case configured to hold a mobile computing device on a first side of the protective case adjacent a back of the mobile computing device that is opposite a screen of the mobile computing device;
a fingerprint sensor on a second side of the protective case, the second side being opposite the first side, such that the second side faces an opposite direction of the screen of the mobile computing device;
a touchscreen display on the second side of the protective case; and
one or more processors and memory storing instructions that, when executed by the one or more processors effectuates operations comprising:
detecting that a transaction has occurred after the fingerprint sensor has been used to confirm a person authorized the transaction;
presenting a first set of options to characterize the transaction on the touchscreen display;
receiving a first selection among the first set of options via the touchscreen display; and
in response to the first selection, presenting a second set of options to further characterize the transaction, the second set of options being selected based on the first selection.

2. The case of claim 1, comprising:
a battery configured to power the one or more processors, the touchscreen display, the memory, and the fingerprint sensor; and
a local area wireless interface configured to communicate with the mobile computing device to engage an antenna of the mobile computing device to convey data from the one or more processors to a remote server system.

3. The case of claim 1, wherein:
The second set of options are selected based on proximity in an embedding space.

4. The case of claim 1, wherein the operations comprise:
determining that an orientation sensor of the case indicates the mobile computing device has been placed screen-side down; and
in response to the determination, causing, by the one or more processors, a microphone and a camera of the mobile computing device to be disabled.

5. The case of claim 1, wherein another selection among the second set of options is obtained in response to detecting that a touch from the first selection has been drawn to a region of the touchscreen display corresponding to one of the second set of options.

6. The case of claim 1, the first set of options and the second set of options being individual words.

7. The case of claim 1, wherein the one or more processors are configured to operate independently of a processor of the mobile computing device, while the mobile computing device is locked.

8. The case of claim 2, comprising an inductive charging interface.

9. The case of claim 8, wherein the inductive charging interface is configured to convey power from the battery to charge the mobile computing device.

10. The case of claim 8, wherein the inductive charging interface is configured to convey power from the mobile computing device to charge the battery.

11. A computer-implemented method, comprising:
receiving, with a computer system, as a result of a scan of a label on a product, a message identifying a person and a product obtained by that person, the message being obtained from an apparatus comprising:
a protective case configured to hold a mobile computing device on a first side of the protective case adjacent a back of the mobile computing device that is opposite a screen of the mobile computing device;
a fingerprint sensor on a second side of the protective case, the second side being opposite the first side, such that the second side faces an opposite direction of the screen of the mobile computing device;
a touchscreen display on the second side of the protective case; and
one or more processors and memory storing instructions that, when executed by the one or more processors effectuates operations comprising:
detecting that a transaction has occurred after the fingerprint sensor has been used to confirm a person authorized the transaction;
presenting a first set of options to characterize the transaction on the touchscreen display;
receiving a selection among the first set of options via the touchscreen display; and
in response to the selection, presenting a second set of options to further characterize the transaction, the second set of options being selected based on the selection;
adding, with the computer system, a record associating the person with the product to an account of the person;
receiving, with the computer system, a request to access the record from an entity other than the person;
determining, with the computer system, an amount of compensation to which the person is entitled in exchange for granting access to the record; and
providing, with the computer system, access to the record and causing the person to receive the compensation.

12. The method of claim 11, comprising:
receiving data from the person characterizing a relationship of the person with the product; and
augmenting the record with the data characterizing the relationship of the person with the product.

13. The method of claim 12, wherein the data specifies an entry in an ontology of candidate reasons for obtaining the product.

14. The method of claim 12, comprising:
inputting the data characterizing the relationship of the person with the product into a trained artificial intelligence model to assist the person with a decision regarding another product.

15. The method of claim 11, wherein:
the label comprises a computer-readable code that identifies the product and locates a network-accessible resource with information about the product.

16. The method of claim 15, wherein the computer-readable code is an optically readable code.

17. The method of claim 15, wherein the computer-readable code is a wirelessly readable code.

18. The method of claim 15, wherein the computer-readable code is encoded on the product with steganography.

19. The method of claim 11, wherein the compensation is determined based on an amount of entropy entailed by the requested access.

20. The method of claim 11, wherein the scan is performed by a computing device of the person.

21. The method of claim 11, wherein the scan is performed by a retailer of the product.

22. The method of claim 11, comprising causing the person to be reminded of an expiration date or use by date of the product based on the record.

23. The method of claim 11, comprising:
steps for creating the label.

24. The method of claim 11, comprising:
steps for augmenting the record.

25. The method of claim 11, comprising:
receiving a selection from the person from among a hierarchical ontology of reasons for purchasing the product.

26. The method of claim 25, wherein:
the hierarchical ontology is presented in a force-directed graph user interface.

27. The method of claim 26, wherein force in a graph of the force-directed graph user interface is based on distance in an embedding space of entries in the ontology.

28. The method of claim 25, wherein the selection is based on audio of the person speaking about their relationship with the product, input to a speech-to-text model.

29. The method of claim 11, wherein:
the record is stored in a data savings account of the person, in a repository having more than 10,000 other data savings accounts of other people, and the data savings account of the person has more than 20 records corresponding to purchases of more than 20 different respective products.

30. A tangible, non-transitory, machine-readable medium storing instructions that when executed by one or more processors effectuate operations comprising:
receiving, with a computer system, as a result of a scan of a label on a product, a message identifying a person and the product obtained by that person;
adding, with the computer system, a record associating the person with the product to an account of the person;
receiving, with the computer system, a request to access the record from an entity other than the person;
determining, with the computer system, an amount of compensation to which the person is entitled in exchange for granting access to the record; and
providing, with the computer system, access to the record and causing the person to receive the compensation.
